(19) United States
(12) Patent Application Publication
(10) Pub. No.: US 2020/0399144 A1
(43) Pub. Date: Dec. 24, 2020

(54) Device And Method For Disinfecting A Fluid By Means Of UV Light

(71) Applicant: HYTECON AG, Luzern (CH)

(72) Inventor: Maximilian Klink, Luzern (CH)

(21) Appl. No.: 16/785,575

(22) Filed: Feb. 8, 2020

(30) Foreign Application Priority Data
Jun. 20, 2019 (DE) 10 2019 116 745.0

(51) Int. Cl. C02F 1/32

(52) U.S. Cl. CPC C02F 1/325; C02F 2301/024; C02F 2201/3222

(57) ABSTRACT

A device is presented for disinfecting a fluid by means of UV light. The device includes: a reactor chamber, which is arranged in the container and adapted to receive a fluid to be disinfected; an inlet, via which the fluid can be introduced into the reactor chamber; an outlet, via which the fluid can leave the reactor chamber; and an irradiation device, which is adapted to provide UV-light rays and to irradiate into the reactor chamber in order to disinfect the fluid therein; wherein the reactor chamber with the inlet and the outlet is adapted to transport the fluid by way a turbulent streamflow from the inlet to the outlet and a fluid guide device facilitating the formation of the turbulent streamflow is provided which has a fluid-guiding element in a reactor chamber area adjacent to the inlet.

### BACKGROUND

UV light, or ultra-violet light, can be used in order to disinfect a fluid, for example water, in particular service water or drinking water.

WO 2017/045 662 A1 discloses a device for disinfecting a fluid by means of UV light as well as the use of said device. In this known device, a container is provided with a reactor chamber in which the fluid to be disinfected is introduced via an inlet and out of which the fluid disinfected by means of UV-light radiation can be discharged. It is provided here that the fluid in the reactor chamber has the form of a rotating fluid vortex. Arranged in the area of a side wall of the reactor chamber are UV-light sources which irradiate UV-light rays on the rotating fluid vortex for disinfection. In one embodiment, the outlet in the known device is formed at a tube section that extends into the reactor chamber.

### SUMMARY

The object of the invention is to specify a device and a method for disinfecting a fluid by means of UV light in which the efficiency of the disinfection of the fluid by means of UV light is improved.

For the achievement of this object, a device as well as a method for the disinfection of a fluid by means of UV light according to independent claims 1 and 12 are provided. Variant embodiments are the object of the dependent claims.

According to an aspect, a device for disinfecting a fluid by means of UV light is produced that comprises the following: a container, a reactor chamber, which is arranged in the container and which is adapted to receive a fluid to be disinfected; an inlet via which the fluid can be introduced into the reactor chamber; an outlet via which the fluid can leave the reactor chamber; and an irradiation device adapted to provide UV-light rays and to irradiate into the reactor chamber in order to disinfect the fluid in the same. The reactor chamber with the inlet and the outlet is adapted to transport the fluid by means of a turbulent streamflow from the inlet to the outlet. A fluid device facilitating the formation of the turbulent streamflow is provided, said device having, in a reactor chamber area adjacent to the inlet, a fluid-guiding element that is configured so as to minimize a non-turbulent streamflow toward the outlet and by this means intensify the turbulent streamflow.

According to a further aspect, a method for disinfecting a fluid by means of UV light that uses the device is provided. The fluid is introduced into a reactor chamber of a container of the device through an inlet and transported in the reactor chamber to the outlet. The fluid is disinfected in the reactor chamber by means of UV-light rays irradiated by an irradiation device into the reactor chamber. The fluid is transported in the reactor chamber by means of a turbulent streamflow from the inlet to the outlet. During this process, a fluid guiding device facilitates the formation of the turbulent streamflow, the non-turbulent streamflow here being minimized toward the outlet by means of the fluid-guiding element in a reactor chamber area adjacent to the inlet, whereby the formation of the turbulent streamflow is intensified.

By means of the fluid-guiding element, the non-turbulent streamflow in the reactor chamber toward the outlet can essentially be completely avoided. The non-turbulent streamflow can be, for example, a laminar streamflow along the tube section.

The fluid guiding device can comprise a plurality of fluid-guiding elements.

Due to the non-turbulent streamflow toward the outlet occurring in known devices, the time spent by the fluid in the reactor chamber is reduced, which limits the efficiency of the disinfection by means of the UV light. This is improved with the aid of the provided fluid-guiding element, which minimizes or prevents that a part of the fluid flows to the outlet without being hit by the turbulent streamflow.

The irradiation device can, for example, be formed with light-emitting diodes (LED), which, as UV-LEDs, provide UV-light rays and irradiate into the reactor chamber.

The reactor chamber can, for example, be configured as a cylindrical interior space in the container.

The reactor chamber can be coated or lined at least in sections with a material that scatters the UV-light rays in a diffuse manner, for example PTFE (polytetrafluoroethylene).

If the inlet is arranged in the area of a wall section of the reactor chamber, the fluid-guiding element can be arranged adjacent to said wall section, for example in a floor or end area if the inlet is arranged, for example, in the area of the floor or an end of the reactor chamber.

The turbulent streamflow in the reactor chamber can comprise eddies, in particular vortices. As a result of the turbulent streamflow, the fluid can circulate several times in the reactor chamber on route from the inlet to the outlet, which further increases the length of time for the UV-light irradiation.

In the device, the fluid-guiding element can be arranged at a distance from the outlet in a distal area of the tube section. If the tube section extends, for example, from the floor or from a lid into the reactor chamber, the fluid-guiding element can be arranged proximally to the floor or to the lid.

The fluid-guiding element in this device can have blade or wing elements extending into the reactor chamber and arranged there in a free-standing manner, which optionally extend, starting from a middle area of the reactor chamber, into an area adjacent to the inner surface of the reactor chamber. A plurality of blade or wing elements can be provided at essentially equidistant intervals. The blade or wing elements can be formed to be three-dimensional, for example resembling wing foils or rotor blades.

The fluid-guiding element can be arranged in the reactor chamber in a movable manner. It can be provided here, for example, that the fluid-guiding element is arranged in the reactor chamber so as to be movable in a free or autonomous manner, for example as a freely rotatable impeller. The fluid-guiding element is arranged in the reactor chamber so as to be rotatable about an axis of rotation. The fluid introduced via the inlet into the reactor chamber can, for example, enter essentially axially to the axis of rotation or perpendicularly to said axis.

Alternatively, it can be provided that the fluid-guiding element is arranged in a fixed manner in the reactor chamber. In an embodiment, the fluid-guiding element can be moved into a plurality of selectable positions, for example by means of rotation about an axis of rotation, in which the fluid-guiding element is respectively fixed, for example by means of a catch mechanism.

In one embodiment, it can be provided that the fluid-guiding element is vertically adjustable on a section of tube. Alternatively, the fluid-guiding element is arranged so as to be fixed and not moveable at all in the reactor chamber.

The fluid-guiding element, for example in the variant with an impeller, can be configured so as to cover a cross section of the (cylindrical) reactor chamber essentially completely. There is no distance or only a small distance between the radially outer ends of the wings here and the inner wall of the reactor chamber, for example a distance of approximately 1 mm up to approximately 5 mm. Alternatively, it can be provided that the fluid-guiding element is configured to cover the cross section of the reactor chamber only partially, for example less than approximately 70% of the cross-sectional area, preferably less than approximately 50% of the cross-sectional area and even more preferably less than approximately 30% of the cross-sectional area.

The fluid-guiding element can be arranged in the longitudinal direction of the reactor chamber in a section of the reactor chamber that is not covered by the irradiation device. The fluid-guiding element in this case is in particular not arranged opposite the irradiation device and thus does not restrict the area of irradiation of the latter.

The constructional height of the fluid-guiding element in the longitudinal direction of the reactor chamber is (many times over) smaller than the length of the reactor chamber in the longitudinal direction. For example, the constructional height of the fluid-guiding element is approximately 20 mm to approximately 50 mm, preferably approximately 20 mm to approximately 40 mm. The reactor chamber can, for example, have a constructional height (in the longitudinal direction) of approximately 100 mm to approximately 900 mm, alternatively from approximately 500 mm to approximately 900 mm.

If the fluid-guiding element is formed with an arrangement of rotating blades or wings, a circumferential wall lying radially to the outside can be provided, at which the wings respectively end or into which the wings merge. The circumferential wall can have at least the same height as the wings. The circumferential wall can be mounted on the exterior of an inner wall of the reactor chamber.

The edges of the blades or wings of the fluid-guiding elements can, in a top view of the flat side of the fluid-guiding element, partially overlap, for example in an area located radially to the outside. Alternatively, in a top view of the flat side of the fluid-guiding element, there is no such overlap.

The fluid-guiding element can be arranged in the reactor chamber opposite the inlet. This way, it can be, for example, provided that the fluid introduced through the inlet into the reactor chamber is streamed toward the fluid-guiding element or flows (directly) toward the latter.

The outlet can be arranged on a tube section. The movably mounted fluid-guiding element can be provided so as to be rotatable about an axis of rotation extending in the longitudinal direction of the tube section.

The tube section can be formed so as to extend from a wall section of the reactor chamber into the reactor chamber, and the outlet can be arranged on an end of the tube section extending into the reactor chamber. The tube section in this embodiment can be arranged essentially in the centre or middle in the reactor chamber so that the fluid in the reactor chamber can be transported around the tube section. For example, the tube section can extend from a floor or a ceiling section of the container into the reactor chamber.

The fluid-guiding element can be configured around the tube section. The fluid-guiding element can be configured around the tube section in an interrupted or continuous fashion.

Further fluid-guiding elements can be arranged on and/or adjacent to the tube section in order to minimize or completely prevent the non-turbulent streamflow along the tube section.

The outlet can be arranged on the tube section in the area of an end surface.

The fluid-guiding element can be configured so as to minimize a non-turbulent streamflow along an outer surface of the tube section toward the outlet and to intensify the turbulent streamflow by this means.

The embodiments described in the foregoing in connection with the device can be provided in a corresponding manner in connection with the method for disinfecting a fluid by means of UV light.

### DESCRIPTION OF EMBODIMENTS

In the following, further embodiments are illustrated in greater detail with reference to the figures, which show:

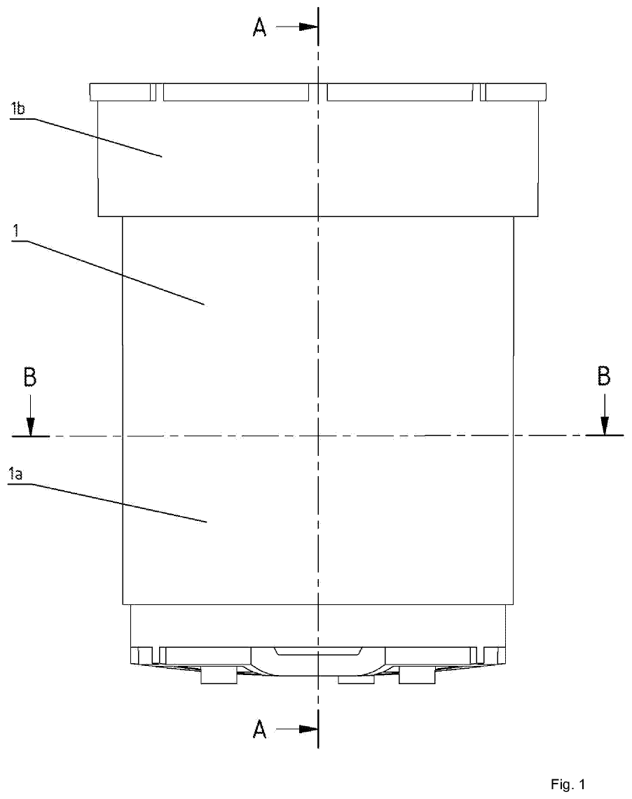

FIG. 1 a schematic representation of a container for a device for disinfecting a fluid by means of UV light;

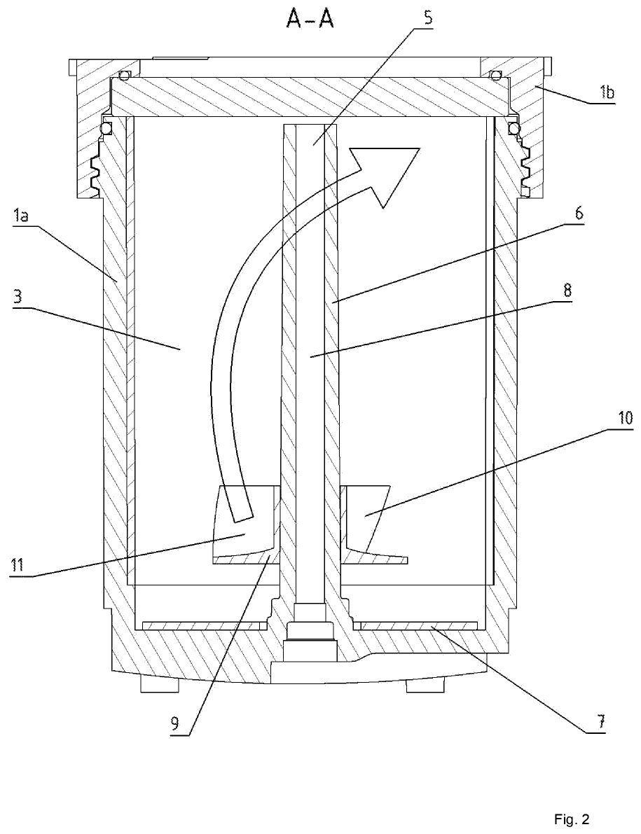

FIG. 2 a schematic sectional representation of the container shown in FIG. 1 along the plane AA indicated in FIG. 1;

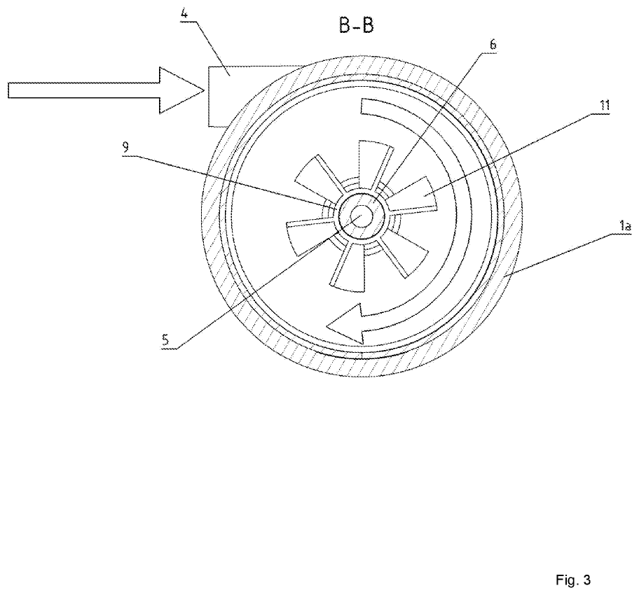

FIG. 3 a schematic sectional representation of the container shown in FIG. 1 along the plane BB indicated in FIG. 1;

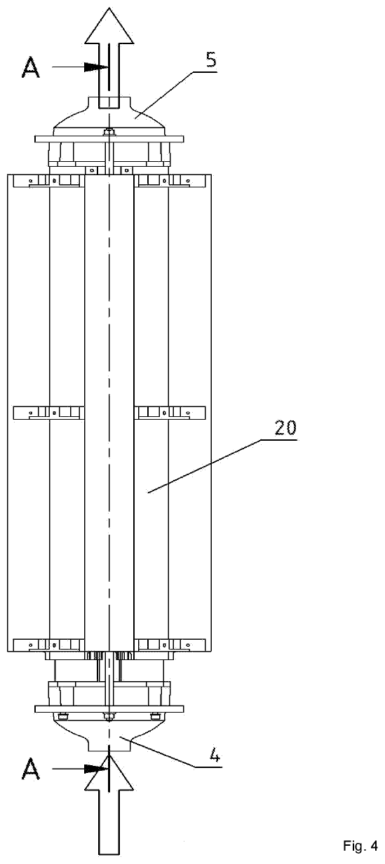

FIG. 4 a schematic representation of a further container for a device for disinfecting a fluid by means of UV light;

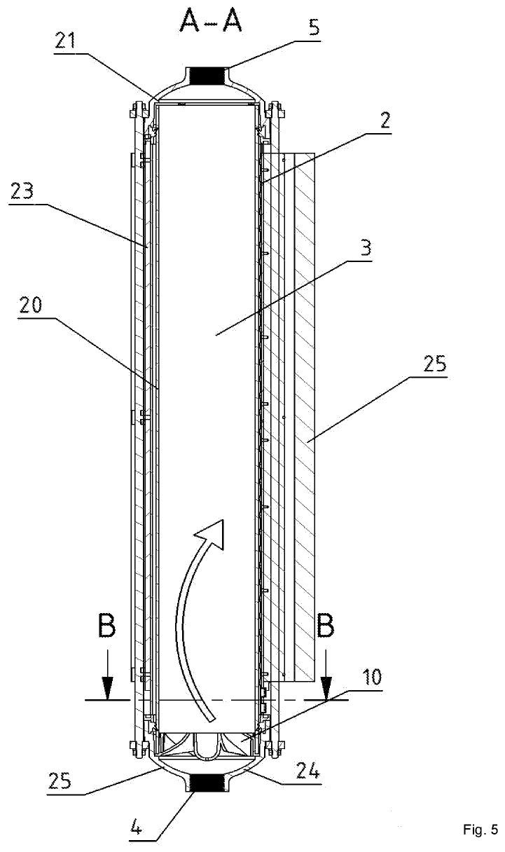

FIG. 5 a schematic sectional representation of the container shown in FIG. 4 along the plane AA indicated in FIG. 4;

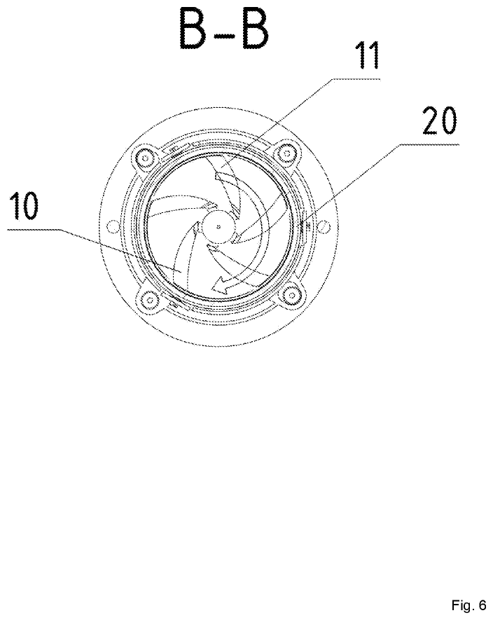

FIG. 6 a schematic sectional representation of the container shown in FIG. 4 along the plane BB indicated in FIG. 4;

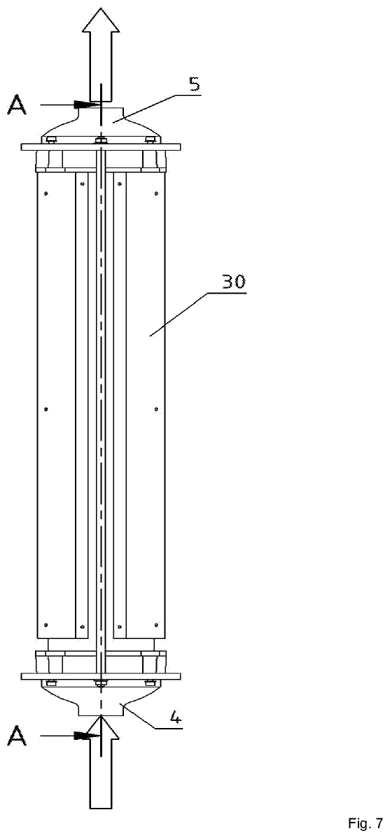

FIG. 7 a schematic representation of another container for a device for disinfecting a fluid by means of UV light;

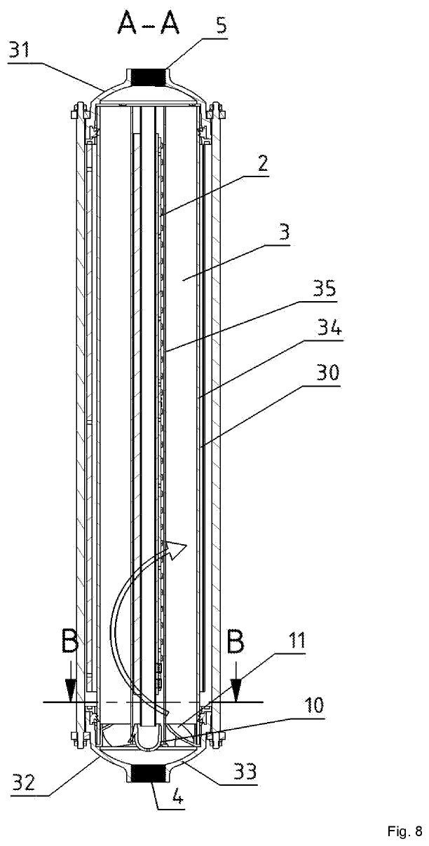

FIG. 8 a schematic sectional representation of the container shown in FIG. 7 along the plane AA indicated in FIG. 4; and

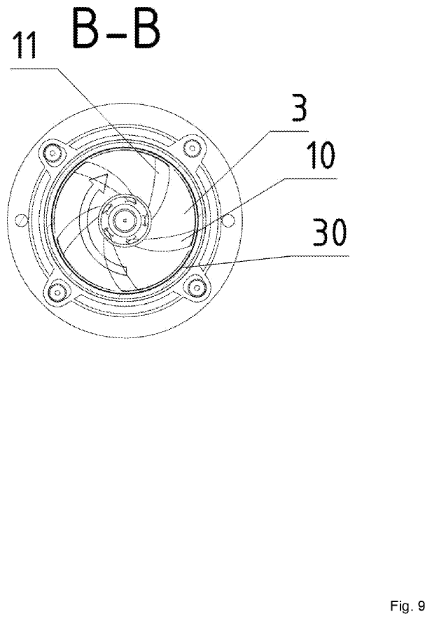

FIG. 9 a schematic sectional representation of the container shown in FIG. 7 along the plane BB indicated in FIG. 4.

FIG. 1 shows a schematic representation of a container 1 for a device for disinfecting a fluid by means of UV light. FIGS. 2 and 3 show sectional representations along the planes AA and BB indicated in FIG. 1.

An irradiation device 2, which provides UV-light rays for disinfecting a fluid in a reactor chamber 3 of the container 1 and which is formed e.g. with UV-LEDs, is indicated schematically by means of dotted lines.

The fluid to be disinfected, in particular water, for example drinking water, enters into the reactor chamber 3 via an inlet 4. The stream of fluid enters here so as to produce a turbulent streamflow in the reactor chamber 3, which in particular causes the fluid in the reactor chamber 3 to circulate several times so that the time spent by the fluid in the reactor chamber 3 is optimized in order to use the UV-light radiation for disinfection.

After the fluid in the reactor chamber 3 has reached the top, it can leave the reactor chamber 3 through an outlet 5, which is formed on the side of an end of a tube section 6, which in turn extends into the reactor chamber 3 from the floor 7 and in which a drain 8 is provided, through which the disinfected fluid can then be guided for further disposal, for example to a water discharge point.

The container 1 features a pot-shaped container 1a as well as a lid 1b, which is screwed on in the illustrated embodiment.

In order to facilitate the formation of the turbulent streamflow of the fluid in the reactor chamber 3, a fluid-guiding device 9 with a fluid-guiding element 10 is provided, which is formed circumferentially on the tube section 6 and which in the illustrated embodiment has blade or wing elements 11 that are arranged at equal intervals around the tube section 11 and that are arranged so as to extend from the tube section 6 into the reactor chamber 3. With the aid of the fluid-guiding element 10, a non-turbulent streamflow of the fluid introduced into the reactor chamber 3 is reduced or essentially completely eliminated along the surface of the tube section 6 toward the outlet. Indeed, the fluid-guiding element 10 facilitates the formation of the turbulent streamflow so that the introduced fluid is exposed to the same to the greatest possible extent. As the fluid flowing along the surface of the tube section 6 temporarily reaches the outlet 5, the outlet 5 is impeded in the illustrated direction by means of the fluid-guiding element 10.

FIG. 4 shows a schematic representation of a further container 20 for a device for disinfecting a fluid by means of UV light. FIGS. 5 and 6 show sectional representations along the planes AA and BB indicated in FIG. 4. In FIGS. 4 to 6, the same references are used as in FIGS. 1 to 3 for the same features.

In the embodiment shown in FIGS. 4 to 6, the inlet 4 and the outlet 5 are arranged in the area of opposite end sections 21, 22 of the further container 20, which is formed with a tube 23, which is, for example, a quartz glass tube. The fluid-guiding element 10, which is configured as a vane or impeller, lies across from the inlet 4 in the area of a floor 24 and is received with its entire constructional height in the lower end section 22. If the further container 21 (i.e. the tube 23) is made of a transparent material and the lower section 22 is made of a non-transparent material (for example plastic), the latter covers the fluid-guiding element 10. The stream of fluid entering via the inlet 4 impinges on the fluid-guiding element 10 essentially perpendicularly to the plane in which the three-dimensionally formed blade and wing elements 11 are arranged.

The further container 20 in various embodiments can have a surface that reflects UV light, preferably in a diffuse manner, on an inner side facing the reactor chamber 3. For this purpose, a coating with PTFE can be provided. The further container 20 can also consist of PTFE, stainless steel or aluminium.

The fluid-guiding element 10 is arranged in the reactor chamber 3 in the longitudinal direction outside an area of the further container 20, which is covered in the longitudinal direction by the irradiation device 2.

The irradiation device 2 providing the UV light for disinfection is formed around the reactor chamber 3 and irradiates from outside into the reactor chamber 3, wherein UV-LEDs can be implemented. A cooling element 25, for example an aluminium cooler, cools the irradiation device 2 during operation. In this or other embodiments, a cooling can be provided with a fluid and/or air.

FIG. 7 shows a schematic representation of another container 30 for a device for disinfecting a fluid by means of UV light. FIGS. 8 and 9 show sectional representations along the planes AA and BB indicated in FIG. 7. In FIGS. 7 to 9, the same references are used as in FIGS. 1 to 3 for the same features.

In the embodiment shown in FIGS. 7 to 9, the inlet 4 and the outlet 5 are arranged in the area of opposite ends 31, 32 of the other container 30. The fluid-guiding element 10, which is configured as a vane or impeller, lies across from the inlet 4 in the area of a floor 33. The stream of fluid entering via the inlet 4 impinges on the fluid-guiding element 10 essentially perpendicularly to the plane in which the blade elements 11 are arranged.

The irradiation device 2 providing the UV light for disinfection is itself arranged in the reactor chamber 3 and is surrounded by the steaming fluid when the latter is transported toward the outlet. For example, UV-LEDs are used here. The reactor chamber 3 is formed by means of tubes 34, 35, which are, for example, made of quartz glass. By means of the tube 33, the irradiation device 2 is separated from the reactor chamber 3 in which the fluid flows. The tube 35 can be a quartz glass tube, and the tube 34 can consist of a robust, structure-defining material, for example quartz glass, stainless steel or plastic. In order to facilitate light reflection in the tube 35, an interior coating can be provided, for example consisting of PTFE or aluminium.

The features disclosed in the foregoing description, in the claims as well as in the drawings can be of importance both when taken alone as well as in any possible combination for the realisation of the various embodiments.

1. A device for disinfecting a fluid by means of UV light, comprising:
a container;
a reactor chamber, which is arranged in the container and adapted to receive a fluid to be disinfected;
an inlet, via which the fluid can be introduced into the reactor chamber;
an outlet, via which the fluid can leave the reactor chamber; and
an irradiation device, which is adapted to provide UV-light rays and to irradiate into the reactor chamber in order to disinfect the fluid therein; wherein the reactor chamber with the inlet, and the outlet is adapted to transport the fluid by means of a turbulent streamflow from the inlet to the outlet and a fluid-guiding device is provided that facilitates the formation of the turbulent streamflow, said fluid-guiding device having a fluid-guiding element in a reactor chamber area adjacent to the inlet, the fluid-guiding element being configured so as to minimize a non-turbulent streamflow toward the outlet and to intensify the turbulent streamflow by this means.

2. The device according to claim 1, wherein the fluid-guiding element is arranged so as to be at a distance in relation to the outlet in a distal area of the tube section.

3. The device according to claim 1 wherein the fluid-guiding element has blade elements extending into the reactor chamber and arranged there in a free-standing manner.

4. The device according to claim 1 wherein the fluid-guiding element is arranged in the reactor chamber across from the inlet.

5. The device according to claim 1, wherein fluid-guiding element is arranged in the reactor chamber in a movable manner.

6. The device according to claim 5, wherein the fluid-guiding element is arranged in the reactor chamber in a rotatable manner about an axis of rotation.

7. The device according to claim 1, wherein in that the outlet arranged on a tube section.

8. The device according to claim 7 wherein the outlet is formed so as to extending from a wall section of the reactor chamber into the reactor chamber, and the outlet is arranged at an end of the tube section extending into the reactor chamber.

9. The device according to claim 7 wherein the fluid-guiding element is configured around the tube section.

10. The device according to claim 7, wherein the outlet is arranged on the tube section in the area of an end plane.

11. The device according to claim 7, wherein in the fluid-guiding element is configured so as to minimize a non-turbulent streamflow along an outer surface of the tube section toward the outlet and to intensify the turbulent streamflow by this means.

12. A method for disinfecting a fluid by means of UV light, comprising:
Providing a device for disinfecting a fluid by means of UV light according to claim 1;
Introducing the fluid through the inlet into a reactor chamber of a container of the device;
Transporting the fluid in the reactor chamber to an outlet; and
Disinfecting the fluid in the reactor chamber by means of UV-light rays irradiated by an irradiation device into the reactor chamber;
wherein the fluid in the reactor chamber is transported by means of a turbulent streamflow from the inlet to the outlet and, at this, a fluid-guiding device facilitates the formation of the turbulent streamflow, which by means of a fluid-guiding element in a reactor chamber area adjacent to the inlet minimizes a non-turbulent streamflow toward the outlet and thereby intensifies the formation of the turbulent streamflow.
